(19) United States
(12) Patent Application Publication
(10) Pub. No.: US 2010/0018927 A1
(43) Pub. Date: Jan. 28, 2010

(54) WATER IONIZER FAUCET AND METHODOLOGY FOR ITS USE

(75) Inventor: Geoff Poole, Reno, NV (US)

Correspondence Address: LONG & CHYBIK, 1575 DELUCCHI LANE, SUITE 32, RENO, NV, 89502, US

(73) Assignee: David Forsyth, Reno, NV (US)

(21) Appl. No.: 12/510,208

(22) Filed: Jul. 27, 2009

Related U.S. Application Data
(60) Provisional application No. 61/083,817, filed on Jul. 25, 2008.

(51) Int. Cl. B01J 47/14; B01J 43/00; B01J 47/00

(52) U.S. Cl. 210/660; 210/198.1; 210/86; 210/137

(57) ABSTRACT

One possible embodiment of the invention could be a water ionizer faucet comprising of a body supporting a first spout, a second spout, and a water control valve, the body being adapted to be attached to a sink having a drain; each spout having an open tip continuously connected to an waterline attachment with the first spout having its open tip being located further away from the body than the other spout tip; and the water control valve that can closeably connect a water supply to a water ionizer.

### CROSS-REFERENCES TO RELATED APPLICATIONS

This application claims the benefit under 35 U.S.C. § 119(e) of U.S. Provisional Patent Application No. 61/083,817, filed on Jul. 25, 2008, the contents of which are relied upon and incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates to faucets and namely, those faucets that are used to dispense treated water from water ionizers.

### BACKGROUND

In personal health and wellness field, there is a popular and well-received awareness that the proper functioning and overall health of the human body requires the body to maintain its general pH status as being slightly basic (alkaline) rather acidic. Correspondingly, when the body does not maintain such a pH, sickness and long term disability could result. The body's proper pH could be maintain by the regular drinking of water that is slightly alkaline and avoiding the intake of liquids and foods that are generally acidic in nature.

One means of obtaining proper alkaline water for drinking is the use of a water ionizer that can take drinking water and make suitable alkaline drinking water from it. To process drinking water as such, the water ionizer could substantially taken in and then pass the intake or drinking water through a filtering means to generally remove, or significantly reduce in quantity, various water contaminants and purification treatment chemicals (e.g. chlorine) but generally leave in the drinking water nutritious minerals and the like. The filtered water may then directed through an ionization chamber, which in many water ionizers, may be separated into halves by a special membrane through which water molecules cannot pass but the ionized minerals can pass. One chamber half could have a positively-charged electrode, while the other chamber half could have a respective negatively-charged electrode. The negatively-charged electrode attracts positively-charged or ionized minerals (e.g., alkaline minerals such as calcium, magnesium, manganese and potassium) to its chamber half, while the positively charged electrode reciprocally attracts negatively-charged minerals (e.g., acidic minerals such chlorine, fluoride, sulfur, phosphorus, bromine, silicon and copper) to the other chamber half. This ionization process takes place while the filtered drinking water is running through the water ionizer. As the water passes through into the ionization chamber, the ions generally move from one chamber half to the other chamber half to substantially create alkaline water effluent and acidic water effluent (generally at respective 70% to 30% ratio.) The ionized water effluent from the alkaline-based half chamber is generally directed to a distribution point outside the water ionizer to allow the user to consume it (e.g., drink it.) The ionized water effluent from the acidic-based chamber half is generally treated as a waste byproduct of the ionization process and is subsequently directed to a drainage facility or drain means outside the water ionizer.

Many such water ionizers could be compact devices running off household electrical and water sources (such as a water from a tap.) Because of the membrane usage in many of the water ionizers, these types of water ionizers generally cannot be pressurized to any great extent as to prevent damage to the membrane. As such, water flow through such water ionizers must generally be controlled upstream, rather than downstream, of the water ionizer. By controlling the water ionizer's intake of tap or drinking water rather that its outflow of ionized water, the untreated water generally enters the water ionizer at the same rate as the ionized water is leaving the device to generally prevent an increase of water pressure within the water ionizer.

For convenience sake, such water ionizers are substantially located by a water source such a sink having one or more water supply taps though which the water ionizer could obtain its intake water. In such setups, the acidic ionized water supply of the water ionizer could be tapped directly into sink's drain. Depending on the actual water ionizer setup, this disposal arrangement could possibly support a significant heath risk should water (e.g., acidic effluent) draining through the sink be subject of a backflow (e.g., siphon) wherein waste water passing through the drain could enter/flow into water ionizer to contaminate the water ionizer, and hence the ionized water product (e.g., that originates downstream of ionizer's water filter means.) In many instances, where the water ionizer is connected directly is to the drain, this kind of connection, (being located below the flood line of the sink, subject to siphoning of waste water and the like) may violate many government health codes regulating plumping and water handling.

What is needed therefor is an upstream water faucet for small water ionizers that could direct subsequent direct alkaline water effluent to user consumption while simultaneously directing acidic water effluent to drain at point that is located above the flood line for the drain (e.g., the sink).

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to control upstream the passage of water through a water ionizer to reduce the potential of water pressure buildup in the ionizer while simultaneously directing acidic effluent to a drainage means at a point above a flood line of a sink;

provide an acidic effluent drainage means for a water ionizer that prevents backflow or siphoning of drainage water into the water ionizer and generally prevents a water pressure buildup in the water ionizer;

the ability to regulate the flow of water through the water ionizer and to direct water ionizer's water outputs to point above a sink's flood line;

provide a double spouted, single control faucet that attaches to a sink for regulating intake of water to a water ionizer and directing discharges of both acidic and alkaline water effluent to a point above a sink's flood line;

the ability to alert an user that a water ionizer requires replenishment of it nutritional minerals stock when the water ionizer that is stored out of site from the user;

provide a faucet controlling the amount of water pressure inside a water ionizer whose drainage means that does not involve directly connecting the water ionizer to a drain; and

provide a faucet that allows for under sink storage of a water ionizer.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a water ionizer faucet comprising of a body supporting a first spout, a second spout, and a water control valve, the body being adapted to be attached to a sink having a drain; each of the spouts having an open tip continuously connected to an waterline attachment with the first spout having its open tip being located further away from the body than the other spout tip; and the water control valve that can closeably connect a water supply to a water ionizer.

A methodology of operating a water ionizer faucet comprising of the following steps: providing a sink with a water supply and a drain means; providing a water ionizer with a water intake, an acidic water output, and alkaline water output; providing a faucet having a body supporting a first and second spouts and a water control valve, the first spout is connected to alkaline water output, the second spout is connected to the acidic water spout and is located above the flood line of the sink, the water control valve is used to connect the water supply to the water intake; supplying water to water ionizer to create acidic and alkaline water effluents; emitting alkaline effluent through the first spout; emitting acidic water effluent through the second spout; and passing acidic water effluent into drainage means.

A water ionizer faucet in combination with an water ionizer comprising of the water ionizer having an water intake, an acidic water output and alkaline water output; the water faucet comprising of a first and second spouts and an water intake control valve, the body is mounted to a sink having a drain, the first spout having a tip whose height from the drain is than greater that the tip of the second spout; wherein the first spout being connected to alkaline water output, the second spout being connected to acidic water output, and water intake control controls the water flowing from the water supply line to water ionizer.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a cutaway perspective view of one embodiment of the present invention.

FIG. 2 is substantially a perspective cutaway view of invention in combination with a sink and water ionizer.

FIG. 3 is substantially a perspective view of another embodiment of the invention.

FIG. 4 is substantially a perspective view of yet another embodiment of the invention.

FIG. 5 is substantially a flowchart for one embodiment of the methodology for the invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

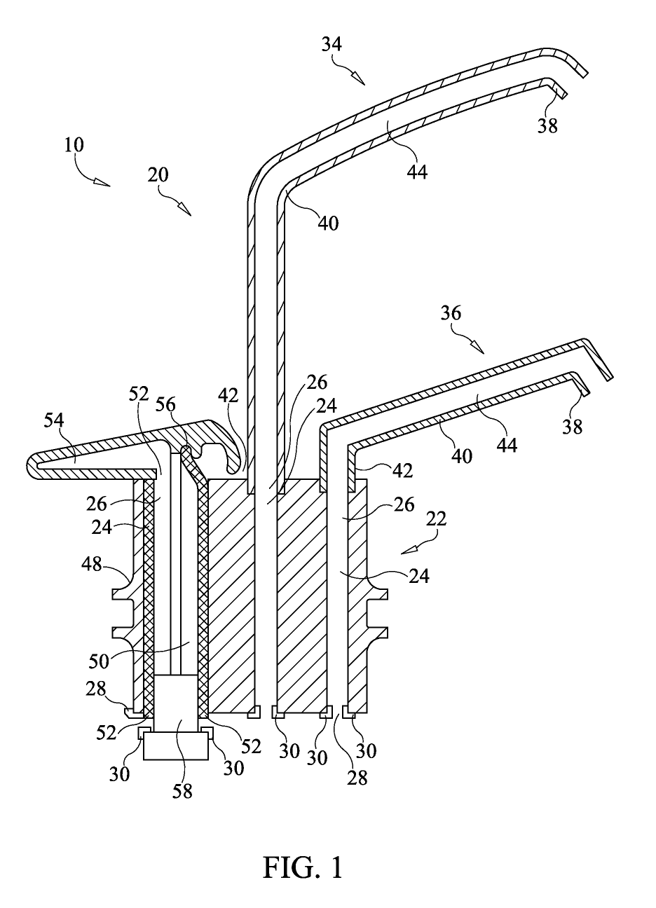

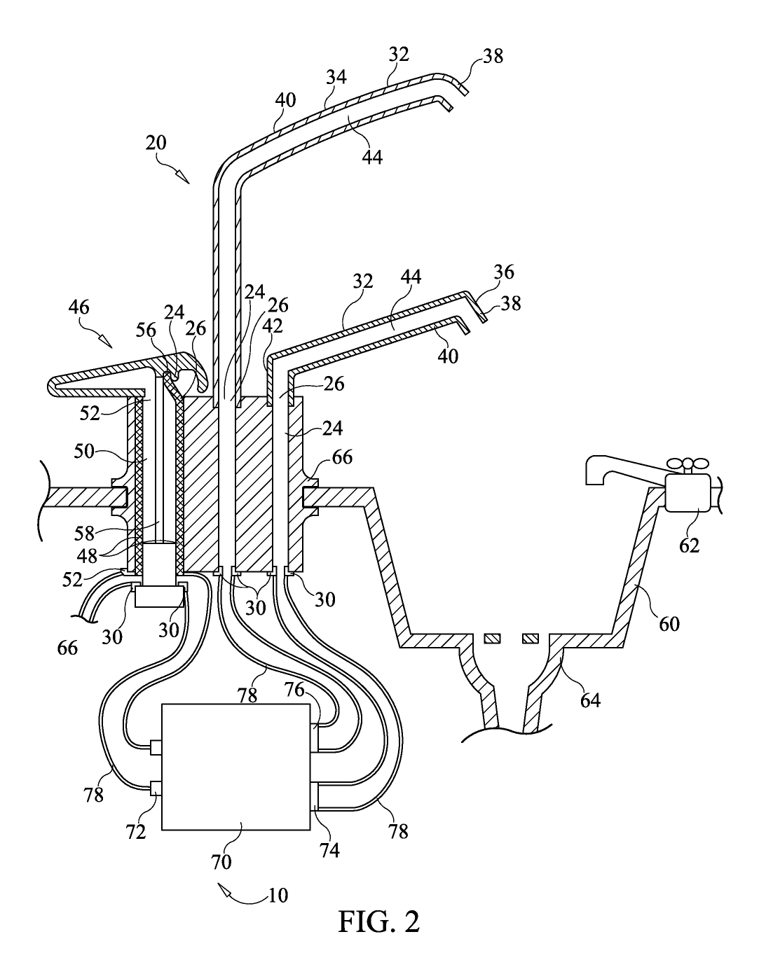

The present invention 10 could be a water ionizer faucet 20 and a methodology 100 for using such a water ionizer faucet mounted on a sink 60 in conjunction with a water ionizer 70 (e.g., a portable household type). As shown in FIG. 1, one possible embodiment of the water ionizer faucet 20 could have a body 22 supporting a first spout 34, a second spout 36, and water control valve 46. The body 22 could be made from a variety of materials and have a wide variety of shapes and styles and still meet the needs of the invention. In at least one embodiment, the body 22 is generally cylindrical in shape and features three open-ended channels 24, with the two spouts 32, and the water control valve 46, each item being assigned to a respective channel 24. Each channel 24 could longitudinally pass through the body 22 to connect a top aperture 26 at the top of the body with a bottom aperture 28 located at the bottom of the body 22. In this manner, each spout 32 could be movably attached to the top aperture 26 of their respective channels 24 to still provide a continuous yet water-tight connection between spout 32 and channel 24. The bottom aperture 28 could incorporate a water line attachment 30 to allow a water line or hose 68 (shown in FIG. 2) to be subsequently attached to the channel 24 to have the hose's interior in continous connection with the channel 24 and the conduit 44 of the respective spout 32.

The channel 24 for the water control valve 46 could receive at least a portion of the water control valve 46 so that the lever 54, handle, or other device allowing a user to control the water control valve 46 could be present proximate to the top of the body 22 while allowing the water line attachments 30 of the water control valve 46 to be presented proximate to the bottom of the body 22 [and when the body 22 is attached to a sink 60 or other such fixture (e.g., as generally shown in FIG. 2), to be presented proximate to the underside of such a fixture.]

The two spouts 32 could each have a curved shape and further feature an opened-ended tip 38, stem 40, and open-ended base 42 in which open-ended tip 38 is continuously connected by a conduit 44 to open-ended base 42. The open-ended base 42 could be configured to be received by a respective top aperture 26 of the body 22 to generally provide a water-tight, yet movable connection of the open-ended base 42 to top aperture 26 (and provide continous connection to bottom aperture 28 and water line attachment 30 as well. Such a connection is well known in the art could be accomplished by a wide variety of means.

The first spout 34 could be designated to handle or dispense alkaline ionized water effluent while the second spout 36 could be designated to handle or dispense acidic ionized water effluent. The first spout 34 could be longer than the second spout 36 in that as attached to the body 22, the first spout 34 could place its tip 38 higher than that of the tip 38 of the second spout 36 [e.g., the tip of the second spout 36 be placed closer to the drainage means 64 (shown in FIG. 2) when the water ionizer faucet 20 is attached to a sink 60 or similar fixture.]

The water control valve 46, in at least one embodiment could be a lever-activated plunger type of valve, (although other types could be used and still be considered within the purview of the invention). The valve 46 could have a cylindrically-shaped case 48, lever 54, and plunger 58. The case 48 could have a hollow case interior 50 generally continuously connected to three case apertures 52 connecting the case interior 50 to the exterior of the case 48. One case aperture 52 could be located proximate the top of the case 48, while the remaining two case apertures 52 are proximate to the bottom of the case 48 (so as to be further attached to a respective water line attachment 30.) The two case apertures 30 at the bottom of the case 48 could be opposingly located from one another on the sides of the case proximate to its bottom. A water line attachment 30 could be attached to each of the bottom case apertures 52.

A plunger 58 could be movably fitted within the case interior 50 with a portion of the plunger 58 passing through the case aperture 52 at the top case 48 to movably connect to the lever 54. As the lever 54 is moved relative to the fulcrum 56, the lever 54 moves the plunger 58 within the interior. One lever movement moves the plunger 58 towards the bottom of case 48 and blocks the two case apertures 52 proximate to the case bottom (preventing liquid such as tap water from passing from one bottom-located case aperture 52 to another) while another lever movement moves the plunger 58 toward the top of the case 48 (allowing liquid to pass from one bottom-proximate case aperture 52 to another.)

As substantially shown in FIG. 2, the water ionizer faucet 20 can be used in combination with a sink 60 (e.g., a fixture-having a drainage means 64, water supply 66, etc.) and the water ionizer 70. The sink 60 could further have ordinary sink faucet(s) 62 as well as a mounting aperture 66 to mount the water ionizer faucet 20 to the sink 60 so that the both water spouts 32 and lever portion of the water control valve 46 are presented at the topside portion of the sink 60 while the water line attachments 30 for both the spout pair and the water control valve 46 are substantially present below the sink 60.

The water ionizer 70 could be could be of a type such as a portable household unit that the operator wishes to operate underneath the sink and generally out of view. The water ionizer 70 could feature a water intake 72, an acidic water outlet 74, and an alkaline water outlet 76. The water ionizer intake and outlets could each further feature water line attachments 30. Hoses 78 could then be used to connect the water ionizer 70 to the water ionizer faucet 20, the connecting hoses having ends that could connect to water line attachments 30 of the water ionizer faucet 20 and water ionizer 70. In this manner, the water intake 72 could be connected to one of the case apertures 52 proximate to the bottom of the case 48. Similarly, the alkaline water outlet 76 could be attached by hose 78 to the first or alkaline spout 34 while the acidic water outlet could be attached by hose 78 to the second or acidic spout 36. The remaining bottom case aperture 52 could be connected by hose 78 to a fitting applied to the water supply for the sink to provide drinking water for the water ionizer 70.

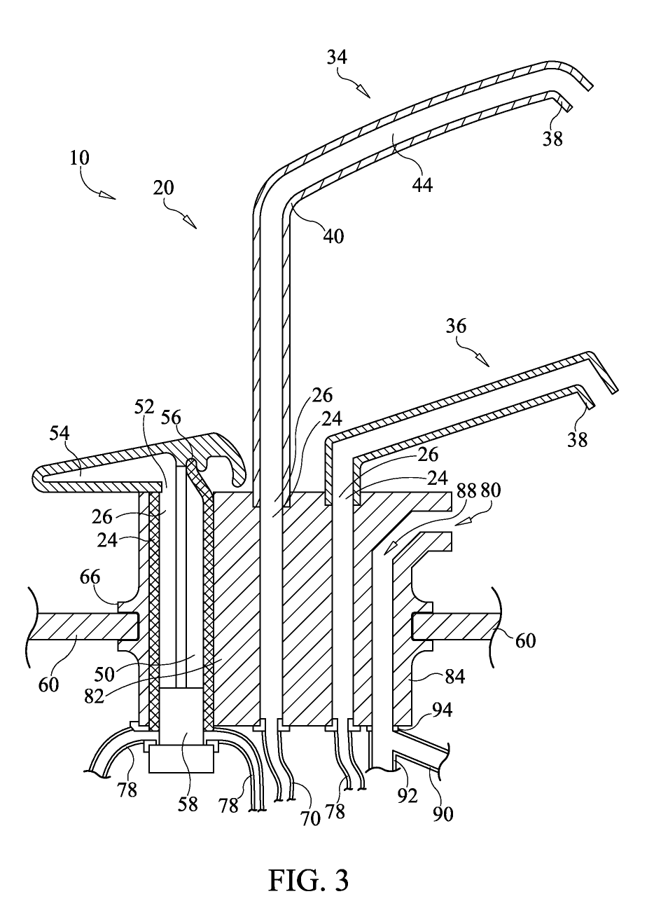

As substantially shown in FIG. 3, at least one possible embodiment could additionally include a dishwasher anti-siphon vent or air gap 80 built into the body 22 to allow the invention 10 be placed in a mounting aperture 66 in the sink 60 that is a pre-existing knockout hole for the placement of an air gap 80 when a dishwasher is already connected to the sink 60.

The body 22 in this embodiment could be made into two side-by-side sections, a valve section 82 and an air gap section 84. The valve section 82 could have all the components and work in the manner as previously-described above for the water ionizer faucet 20. The air gap section 84 could have an air gap aperture 86 in the side of body 22 that connects a hollow air gap chamber 88 formed by the air gap section 84 to the exterior of the body 22. The bottom of the air gap chamber 88 could be a pair of vent hose connectors 94, which may be used to continuously connect or vent the air gap chamber 88 to two hoses 78, a dishwasher vent hose 90 connecting air gap 80 to the drain of a dishwasher, and a drainage vent hose 92 connecting the air gap 80 to the drainage means 64 of the sink 60.

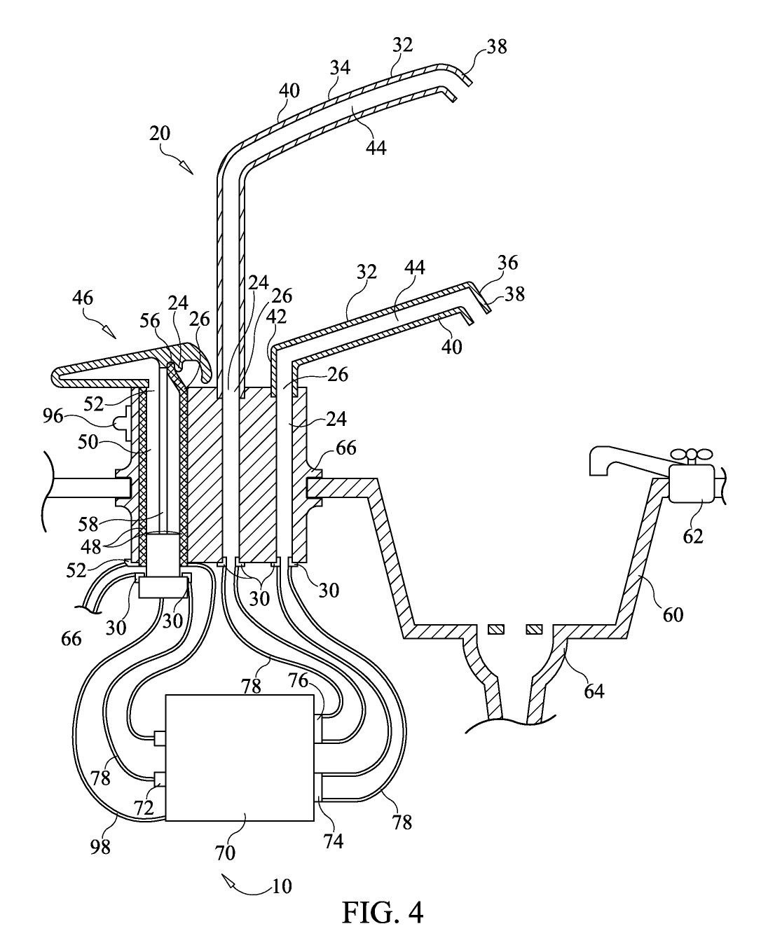

A substantially shown in FIG. 4, another embodiment of the invention 10 could place a user alert device 96 (such as a LCD or LED or other suitable information display apparatus) on the body 22 for viewing by the user of the invention 10. The device 94 could be connected by wire 96 to the water ionizer 70 that has a feature of adding materials (such as nutritional minerals) to the ionized water and the feature of a water analyzer detector that measures the amount of inserted minerals in the ionized water. When the water analyzer detector determines that the mineral content of the ionized water falls below a set of parameters, it could cause the water ionizer to send an electrical signal through the wires 98 to the use alert device 96, causing the device 96 to be come activated (e.g. turn on, show a light, etc) or deactivated (turn off a light) to communicate to the user that the mineral adding ability of the water ionizer 70 has to be replenished with a new amount of replenishable, nutritional, mineral stock.

Methodology

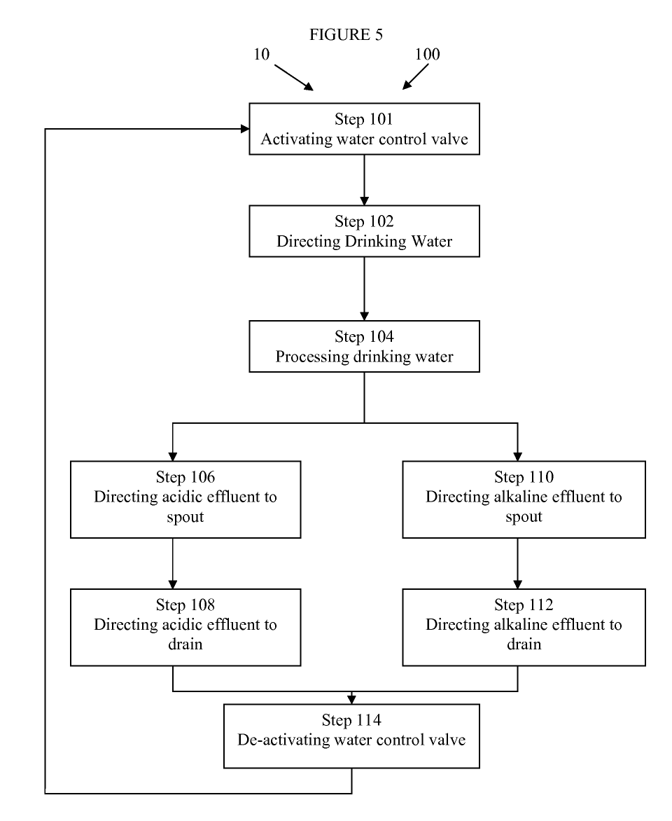

As shown in FIG. 5, one possible methodology or process 100 of operating the water ionizer faucet 20 could begin with step 101 wherein the user activates the water control valve 46 (by moving the lever 54) causing the plunger 58 to moves up the case interior 50 away from the bottom of case 48. This allows drinking water to pass from one bottom case aperture 52, through a portion of the case interior 50 (the plunger providing a water tight fit to the case interior 50 so the supply of drinking water does not go through the top case aperture 52) to the remaining case aperture 52 proximate to the bottom. Once generally completed, the process 100 could proceed to step 102.

In step 102, directing drinking water through a respective hose 78 to the water intake 72 of the water ionizer 70. The water control valve 46, by being upstream of the water ionizer 70, generally prevents the serious increase of water pressure (generally, the amount of water entering into the water ionizer 70 should equal in the amount and flow the ionized waters leaving the water ionizer 70) during water ionizer operations that could otherwise damage the water ionizer 70.

Step 104 could be the processing of drinking water into different types of ionized water by the water ionizer 70. From Step 104, the process proceeds simultaneously to steps 106 and 110.

At step 106, the acidic ionized effluent water is then directed out of water ionizer 70 at acidic water outlet and taken by hose 78 to the second or acidic water spout 36. At step 108, the acidic ionized water is then substantially directed through the spout 36 to its tip 38 to the drainage means 64 of the sink 60. The construction and positioning of the second or acidic water spout 36 and hence its tip 38 ensures that acidic water affluent is first directed to the drainage means 64 from well above the flood line 68 of the sink 60.

In Step 110, the alkaline ionized water effluent is directed out of the alkaline water outlet 76 and through its respective hose 78 to the alkaline or first spout 34. In step 112, alkaline ionized water effluent passes through the first spout 34 and discharged out its tip 38 so that the affluent can pass onto the sink. The positioning of the tip 38 of the spout 34, the body 22, and sink 60 makes it relatively easy for the user to obtain the discharged or emitted alkaline water effluent from the invention (put it in a drinking glass or the like for consumption.) In at least one embodiment, wherein the faucet body further includes an air gap allowing the drain means of the sink and the drain of the dishwasher to be connected to and vented by the air gap.

From both steps 108 and 110, the process 100 could proceed to step 114 where, the lever 54 on the water control valve 46 is moved to stop the flow of drinking water to the water ionizer 70. If more ionized water is desired later, the process can move on to step 101.

### CONCLUSION

As substantially shown through the specification and figures, the invention generally provides for a water ionizer faucet provides for above sink flood line discharge of acidic ionized water affluent to a drainage means; upstream control from the water ionizer of the water intake supply; reducing the occurrence of water pressure building in the water ionizer; minimizing damage to the water ionizer that can occur to water pressure build-up; incorporating a dishwater air gap into the invention; allowing the invention to be mounted in pre-existing knock outs for air gap devices; and providing a user communication device in combination with a water ionizer having mineral supplement ability to inform the user that the ionizer's mineral stock is low and needs to be replenished.

Although the description above contains many specifications, these should not be construed as limiting the scope of the invention but as merely providing illustrations of some of the presently preferred embodiments of this invention.

What is claimed is:

1. A water ionizer faucet comprising of:
(A) a body supporting a first spout, a second spout, and a water control valve, the body being adapted to be attached to a sink having a drain;
(B) the first and second spouts, each spout having an open tip continuously connected to an waterline attachment with the first spout having its open tip being located further away from the body than the other spout tip; and
(C) the water control valve that can closeably connect a water supply to a water ionizer.

2. The apparatus of claim 1 wherein the body further incorporates an air gap.

3. The apparatus of claim 1 wherein a water ionizer when connected to the water ionizer faucet directs alkaline water through the first spout and directs acidic water through the second spout.

4. The apparatus of claim 1 wherein the open tip of the second spout is closer to the body than the open tip of the first spout.

5. The apparatus of claim 1 further comprising of a user alert device attached to the body to alert a user of low levels of replenishable nutritional mineral stock of the water ionizer.

6. The apparatus of claim 1 further comprising of a user alert device that is electronically connected to a water ionizer.

7. The apparatus of claim 1 wherein the hose connections for the first spout, second spout, and water control valve are underneath the sink to which the water ionizer faucet is attached.

8. The apparatus of claim 7 wherein the water ionizer to which the water ionizer faucet is connected is stored underneath the sink to which the water ionizer faucet is attached.

9. A methodology of operating a water ionizing faucet comprising of the following steps, but not necessarily in the order shown:
(A) providing a sink with a water supply and a drain means;
(B) providing a water ionizer with a water intake, an acidic water output, and alkaline water output;
(C) providing a faucet having a body supporting a first and second spouts and a water control valve, the first spout is connected to alkaline water output, the second spout is connected to the acidic water spout and is located above the flood line of the sink, the water control valve is used to connect the water supply to the water intake;
(D) supplying water to water ionizer to create acidic and alkaline water effluents;
(E) emitting alkaline effluent through the first spout;
(F) emitting acidic water effluent through the second spout; and
(G) passing acidic water effluent into drainage means.

10. A methodology of claim 9 of mounting the body in an air gap knockout hole of a sink.

11. A methodology of claim 9 further comprising the step of venting through the facet a drain means of a sink and drain of a dishwasher.

12. A methodology of claim 9 further comprising the step of storing the water ionizer below the sink.

13. A methodology of claim 9 further comprising of discharging acidic water effluent from above the flood line of the sink.

14. A water ionizer faucet in combination with an water ionizer comprising of:
(A) the water ionizer having an water intake, an acidic water output and alkaline water output;
(B) the water faucet comprising of a first and second spouts and an water intake control valve, the body is mounted to a sink having a drain, the first spout having a tip whose height from the drain is than greater that the tip of the second spout;
wherein the first spout being connected to alkaline water output, the second spout being connected to acidic water output, and water intake control controls the water flowing from the water supply line to water ionizer.

15. The combination of claim 14 wherein the water control valve is located upstream from water ionizer to prevent serious increase of water pressure within the water ionizer during operation.

16. The combination of claim 14 further wherein the second spout is located above the floodline of a sink.

17. The combination of claim 14 wherein the water line attachments for the spout pair and the water control valve are located beneath the sink.

18. The combination of claim 14 wherein the body further incorporates an air gap.

19. The combination of claim 18 wherein the body is mounted in an air gap knockout hole of the sink.

20. The combination of claim 14 wherein the body further supports a user alert device, electronically attached to the water ionizer, that alerts the user that the nutritional mineral dispensed by the water ionizer needs to be replenished.
